(19) United States
(12) Patent Application Publication
(10) Pub. No.: US 2024/0223688 A1
(43) Pub. Date: Jul. 4, 2024

(54) Clockwise

(71) Applicant: Mario Daniel Flores, Mcallen, TX (US)

(72) Inventor: Mario Daniel Flores, Mcallen, TX (US)

(21) Appl. No.: 18/493,621

(22) Filed: Oct. 24, 2023

Related U.S. Application Data
(60) Provisional application No. 63/477,545, filed on Dec. 28, 2022.

(51) Int. Cl. H04M 1/04

(52) U.S. Cl. CPC H04M 1/04

(57) ABSTRACT

A phone holder device is provided. The device includes a lower part having a plurality of fasteners and a closure with plurality of balls placed in the closure; a spinning part rotatably attached to the center of the lower part, the spinning part is configured to rotate around the center of the spinning part; and a top plate attached to the spinning part.

### FIELD OF THE INVENTION

The present invention relates to a smartphone holder for a vehicle. More particularly, the present invention relates to a smartphone holder for a vehicle's steering wheel.

### BACKGROUND OF THE INVENTION

A smartphone holder for a vehicle steering wheel is in demand. Today, people use smartphones to do anything from updating Facebook profiles to booking hotel rooms. In addition, many individuals use smartphones in their cars for navigation via the smartphone's GPS function during their trips.

Smartphones are indispensable electronic devices in all aspects of modern life. Thus, many manufacturers provide smartphone holders that are designed to be used in vehicles. Such a smartphone holder can be used to allow the driver to initiate or receive phone calls or manipulate the smartphone easily when sitting behind the vehicle's steering wheel.

Recently, smartphone screen visibility has improved in terms of navigating or using internet-based apps, and smartphone usage has also increased. As a result, the need for a vehicle-mounted smartphone holder has been growing.

Some existing smartphone holders are designed to attach to a dashboard using adhesive or attach to a vehicle windshield using an adhesion plate.

In most cases where a smartphone holder is attached to the dashboard or windshield of the vehicle, the phone will be located in the middle of the dashboard or to one side of the driver's position. An inconveniently placed phone may impede the driver if the driver cannot see the phone screen clearly, for example, while using the phone to navigate, which may be dangerous and cause distraction. Therefore, there is a need to develop a phone holder designed to solve this problem.

The present invention is intended to solve problems associated with conventional phone holder devices and improve on the design and construction of these devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

A phone holder device is provided. The device includes a lower part having a plurality of fasteners and a closure with plurality of balls placed in the closure; a spinning part rotatably attached to the center of the lower part, the spinning part is configured to rotate around the center of the spinning part; and a top plate attached to the spinning part. In one embodiment, the closure of the present invention includes a bottom plate having a sticky material.

In another embodiment, the top spinning part of the spinning part includes a plurality of magnets.

In some embodiments, the closure includes a bottom plate and the top plate includes a rubber material.

### BRIEF DESCRIPTION OF THE DRAWINGS

FIG. 1 is an illustration of one embodiment of the present invention.

FIG. 2 is a side view of one embodiment of the present invention.

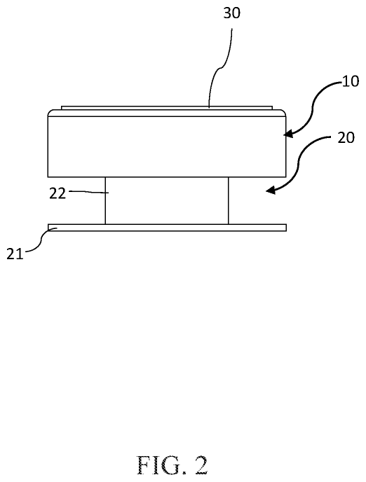

FIG. 3 is an illustration of one embodiment of the lower part of the present invention.

FIG. 4 is an illustration of one embodiment of the spinning part of the present invention.

FIG. 5 is an exploded view of one embodiment of the present invention.

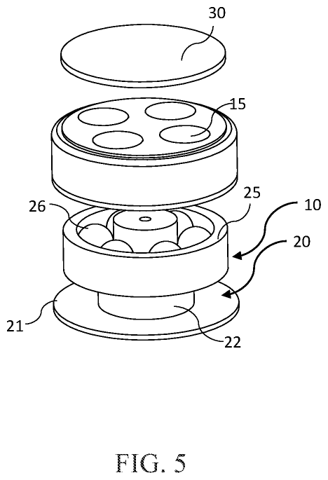

### DETAIL DESCRIPTIONS OF THE INVENTION

All illustrations of the drawings are for the purpose of describing selected versions of the present invention and are not intended to limit the scope of the present invention.

The present invention provides a phone holder device that will allow drivers to safely engage in audio and video calls and navigate via GPS using their cell phone.

The present invention positions the cell phone at the center of the vehicle's steering wheel, which will allow the driver to glance at the screen without looking away from the road.

The present invention will secure the smartphone so that the driver does not have to hold the phone in his/her hand, place it in or on the vehicle's cup holder, or use an inconveniently placed phone holder that forces the driver to look down or away from the road. The present invention will also allow the driver easy access to the smartphone's touchscreen at all times.

The present invention will secure the user's smartphone so that it will not fall and slide under the seats. Without such a distraction, the user's eyes will be on the road, and the user's hands can firmly grasp the steering wheel without interruption. The present invention will provide a safe and convenient phone holder.

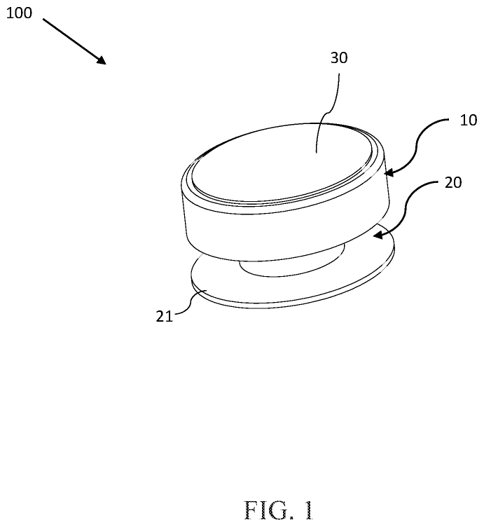

As shown in FIGS. 1 - 5, the present invention provides a phone holder device 100 that may have various components including a rubber buffer, a plurality of magnets, a plurality of bearings, a double-sided attachment panel, a thin piece of sheet metal, and a plurality of fasteners.

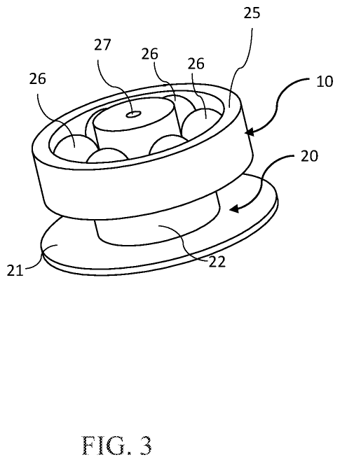

In one embodiment, the phone holder device (device) 100 may comprise a lower part 20 having a closure 25 with plurality of balls (bearings) 26 placed in the closure 25 as shown in FIG. 3; a spinning part (upper part) 10 rotatably attached to the center of the lower part 20, the spinning part 10 is configured to rotate around the center of the spinning part 10; and a top plate 30 attached to the spinning part 10.

The lower part 20 may include the double sided attachment panel (bottom plate) 21 and plurality of fasteners 22. The top plate 30 may include the rubber buffer or any rubber material known in the art and the thin piece of sheet metal.

In another embodiment, the closure 25 may include a bottom plate 21 having a sticky material.

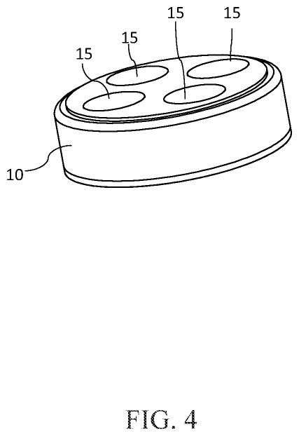

In some other embodiments, the top spinning part 10 includes a plurality of magnets 15 as shown in FIG. 4.

In some embodiments, the closure 25 includes a bottom plate 21.

It should be noted that any components of the present invention may include any other shape including a circular cylindrical shape.

In one embodiment, the rubber buffer can be attached to the plurality of magnets 15, shown on FIG. 4 which may be rotatable by being connected to the plurality pf bearings 26.

In one embodiment, the plurality of bearings 26 may be placed on fastener 22 (which can be a plate or rod in some embodiments) that can be attached to the double-sided attachment panel which can be attached to or included in the bottom plate 21.

The thin piece of sheet metal (bottom plate 21 or top plate 30) can be detachably attached to the rubber buffer which may be an added component of the present invention.

The plurality of fasteners 22 can include a washer and double-sided sticky tape that can be used to attach the components of the present invention. Such fasteners 22 may include screws, rivets, bolts, staples, or other fasteners known to those of skill in the art. The present invention may include one more holes or openings 27 configured to accommodate the fasteners 22. The holes or openings 27 may be placed in any suitable location of the present invention.

To use the present invention, a user can install the phone holder device on the center of the steering wheel, via a sticky double-sided dashboard attachment panel (which can be a bottom plate 21 with a tape).

In addition, the user can install the thin sheet metal plate (bottom 21 or top plate 30) (which can feature a small circular shape) with double-sided sticky tape on the upper half of the back of the cell phone (enabling the magnets 26 to work).

The magnetic surface on the present device may comprise the rubber buffer surface (top plate 30) attached to the magnets 26. This surface will hold the smartphone in place when it adheres to the thin piece of sheet metal (bottom plate 21) attached to the back of the phone. A rubber buffer will keep the phone from sliding, getting scratched, or making sounds caused by driving vibrations.

The present invention can operate via a metal bearing 26, along with the effects of gravity, to maintain the phone in an upright position at all times.

As the user turns the steering wheel during the course of normal driving conditions, the phone attached to the present invention will remain in the upright position, maintaining the screen orientation to make it easy for the user to see and operate the phone while the user's eyes remain on the road.

In some embodiments, the present invention may include additional components, such as a cell phone clip with a battery pack as optional components. Such a cell phone clip and battery pack combination can be configured to clip onto the phone after the present invention is attached to the steering wheel.

Although the invention has been explained in relation to its preferred embodiment, it is to be understood that many other possible modifications and variations can be made without departing from the spirit and scope of the invention.

What is claimed is:

1. A device comprising:
a lower part having a plurality of fasteners and a closure with plurality of balls placed in the closure;
a spinning part rotatably attached to the center of the lower part, the spinning part is configured to rotate around the center of the spinning part; and
a top plate attached to the spinning part.

2. The device as claimed in claim 1, the closure includes a bottom plate having a sticky material.

3. The device as claimed in claim 2, the top spinning part includes a plurality of magnets.

4. The device as claimed in claim 2, the closure includes a circular shape.

5. The device as claimed in claim 1, the closure includes a bottom plate.

6. The device as claimed in claim 5, the bottom plate includes a circular shape.

7. The device as claimed in claim 5, the top plate includes a rubber material.

8. A device comprising:
a lower part having a plurality of fasteners and a closure with plurality of balls placed in the closure;
a spinning part rotatably attached to the center of the lower part, the spinning part is configured to rotate around the center of the spinning part; and
a top plate having a rubber material, the top plate attached to the spinning part.

9. The device as claimed in claim 8, the closure includes a bottom plate.

10. The device as claimed in claim 9, the top spinning part includes a plurality of magnets.

11. The device as claimed in claim 9, the closure includes a circular shape.

12. The device as claimed in claim 10, the closure includes a bottom plate.

13. The device as claimed in claim 12, the bottom plate includes a circular shape.

14. A device comprising:
a lower part having a plurality of fasteners and a closure with plurality of balls placed in the closure having a sticky material;
a spinning part rotatably attached to the center of the lower part, the spinning part is configured to rotate around the center of the spinning part; and
a top plate attached to the spinning part.

15. The device as claimed in claim 14, the closure includes a bottom plate.

16. The device as claimed in claim 15, the top spinning part includes a plurality of magnets.

17. The device as claimed in claim 14, the closure includes a circular shape.

18. The device as claimed in claim 17, the closure includes a bottom plate.

19. The device as claimed in claim 14, the bottom plate includes a circular shape.

20. The device as claimed in claim 19, the top plate includes a rubber material.
